(19) United States
(12) Patent Application Publication
(10) Pub. No.: US 2021/0339116 A1
(43) Pub. Date: Nov. 4, 2021

(54) CRAPS GAME WITH A REPEATED NUMBER BASED WAGERING AREA

(71) Applicant: Repeater Bets, LLC, Indianapolis, IN (US)

(72) Inventor: John L. Cua, Indianapolis, IN (US)

(73) Assignee: Repeater Bets, LLC, Indianapolis, IN (US)

(21) Appl. No.: 17/305,903

(22) Filed: Jul. 16, 2021

Related U.S. Application Data
(63) Continuation of application No. 16/288,597, filed on Feb. 28, 2019, now abandoned.
Application No. 16/288,597 is a continuation of application No. 15/657,556, filed on Jul. 24, 2017, now abandoned.
Application No. 15/657,556 is a continuation of application No. 15/041,176, filed on Feb. 11, 2016, now abandoned.
Application No. 15/041,176 is a continuation of application No. 14/311,789, filed on Jun. 23, 2014, now abandoned.
Application No. 14/311,789 is a continuation of application No. 13/681,452, filed on Nov. 20, 2012, now abandoned.

(51) Int. Cl. A63F 3/00; A63F 9/04

(52) U.S. Cl. CPC A63F 3/00157; A63F 2003/00164; A63F 9/04

(57) ABSTRACT

A craps game is disclosed that combines traditional craps wagers with a set of wagers having longer odds, and thus higher payouts, which are determined based upon the matching of a predefined set of numbers a specified number of times with the roll of the dice prior to the occurrence of a terminating event. In one form, the set of numbers is a single number. In a further form, at least one wager includes a specified number which matches the predefined number which makes up a single member set.

### CROSS REFERENCE TO RELATED APPLICATIONS

The present application is a continuation patent application of U.S. patent application Ser. No. 16/288,597, filed Feb. 28, 2019, which is a continuation of U.S. patent application Ser. No. 15/657,556 filed Jul. 24, 2017, which is a continuation of U.S. patent application Ser. No. 15/041,176 filed Feb. 11, 2016, which is a continuation of U.S. patent application Ser. No. 14/311,789 filed Jun. 23, 2014, which is a continuation of U.S. patent application Ser. No. 13/681,452 filed Nov. 20, 2012, which is hereby incorporated by reference in its entirety to the extent not inconsistent.

### FIELD OF THE INVENTION

The present disclosure broadly concerns a craps game layout and a method for operating a craps game that includes a wagering area for placing bets which are premised upon numbers being rolled repeatedly. More particularly, the present disclosure relates to a craps game layout and a method for operating a craps game that includes a wagering area for placing bets with longer odds which are paid upon the repeated rolling of one or more numbers, either sequentially or not, prior to the occurrence of another specified event.

### BACKGROUND

Legalized gambling in the United States has grown dramatically over the past twenty years. A large contributor to this growth is the legalization of casinos, including tribal casinos and riverboats, around the country. In 2007, legalized gambling revenues topped $90 billion.

Craps is one of many traditional “pit” games offered by a casino which, in combination with other forms of gambling, help them to generate their revenue. The game of craps is played with dice on a specialized table and is often a favorite among gamblers due to its relatively small house edge and its exciting interactive nature. In craps, a player (typically referred to as the “shooter”) rolls a pair of dice which determine if all of the players' bets are won or lost. For example, a single roll may win some bets, lose some bets, and not affect other bets. Furthermore, which player is the “shooter” rotates around the table so that each player has her/her turn rolling the dice. Despite the random outcome of the dice, players enjoy actively participating in the randomly determined outcome of the craps game. In fact, many players profess to possess a special prowess or technique which enables them to be a particularly good shooter. In contrast, other pit games, such as roulette and blackjack, the cards dealt by a dealer primarily determine the outcome of the game.

In addition to physical participation, craps players enjoy the camaraderie of the game. At a craps table, many players commonly place the same bets on particular rolls or combination of rolls of the dice. For example, most players place a bet on the “pass line” along with an “odds” bet. Accordingly, the players all have a common rooting interest in seeing the shooter succeed and the players' joint celebrations can become quite exhilarating when a table is running hot.

Along with the standard “pass line” and “odds” bets, the game of craps provides a variety of bets for players. For example, a player may bet that a “hard 8”, will be rolled by the “shooter” before a tradition “easy 8” or the shooter “craps out”. Alternatively or additionally, a player may “place the 8”, thereby betting that an 8 will be rolled before a 7 or a seven out. Given the variety of bets, the respective payoffs offered at the craps table vary as well depending on the odds of the dice outcome which would win the bet occurring and the house edge. This variety of bets further sets the game of craps apart from baccarat and blackjack, which have much more of a standard bet on only one outcome or another, with few if any opportunities to win more than your initial bet amount.

One apparent disadvantage to the game of craps from the casino's perspective is that sophisticated craps players understand the true odds of most bets. As such, these players typically only place bets on those that have the lowest house edge (or vigorish). In addition, sophisticated craps players seek out casinos that offer craps tables with wagering opportunities, such as 10× odds bets. These advantageous wagering opportunities, however, further decrease the already thin house advantage of the host casino. As a result, many casinos choose not to market themselves to sophisticated craps players. Rather, casinos seek to attract new, lesser experienced players to the craps table.

The best source of potential new players for a game within a casino is also the largest—casual gamblers and/or slot machine players. Most players and casual gamblers are attracted to slot machines as they provide for varied winnings, including the potential for the player to win thousands of dollars, if not millions in the case of a progressive slot machine, from a small single bet. Furthermore, slot machines are typically easy to play and understand. Despite the appeal of jackpots and large payoff opportunities, casinos have traditionally not included large jackpots in the game of craps. Most commonly, the highest payoff in a craps game is 30 to 1, which is only paid when the next roll of the dice results in two ones or two sixes (known as “snake eyes” and “boxcars” respectively). Accordingly, slot machine players are not typically attracted to craps, or other traditional pit games for that matter, as they do not provide this opportunity. However, if this large and quick win could be successfully incorporated into the game of craps, slot machine players and other casual gamblers could be further enticed to play and learn the game of craps. Furthermore, by maintaining the tradition craps game bets, the casino will enable itself to both attract new players to its craps tables while maintaining its sophisticated craps players.

Accordingly, it is an object of the present invention to provide a craps game that offers longer odds bets to attract new players to the game but also retains the traditional bets of a craps game.

### SUMMARY

Various wagers for being incorporated into a craps game are disclosed. In one embodiment, a craps game is provided with include a table layout which provides for a one or more wagers having longer odds than those offered by traditional craps game wagers which are determined based upon the matching of a predefined number a specified number of times with the roll of the dice prior to the occurrence of a terminating event. In a further embodiment, at least one wager includes a specified number which matches the predefined number.

In another embodiment, a craps game is provided with include a table layout which provides for a one or more wagers having longer odds than those offered by traditional craps game wagers which are determined based upon the matching of a predefined plurality of numbers a specified number of times, either sequentially or not, with the roll of the dice prior to the occurrence of a terminating event, without requiring that each number be rolled.

Further objects, features and advantages of the present invention shall become apparent from the detailed drawings and descriptions provided herein. Each embodiment described herein is not intended to address every object described herein, and each embodiment does not include each feature described. Some or all of these features may be present in the corresponding independent or dependent claims, but should not be construed to be a limitation unless expressly recited in a particular claim.

### BRIEF DESCRIPTION OF THE DRAWINGS

FIG. 1 is a plan view of a craps table layout with a repeated number based wagering area that provides multiple wagers according to one form of the present invention.

FIG. 2 is a plan view of an alternate craps table layout with a repeated number based wagering area that provides multiple wagers according to another form of the present invention.

FIG. 3 is a plan view of another alternate craps table layout with a repeated number based wagering area that provides multiple wagers according to yet another form of the present invention.

FIG. 4 is a plan view of yet another alternate craps table layout with a repeated number based wagering area that provides multiple wagers according to another form of the present invention.

FIG. 5 is a perspective view of a further form of the craps table layout of FIG. 2 having a repeated number based wagering area that provides multiple wagers, including electronic indicia of the progress toward those wagers, according to another form of the present invention.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Additionally, in the following description, like reference characters designate like or corresponding parts throughout the several views.

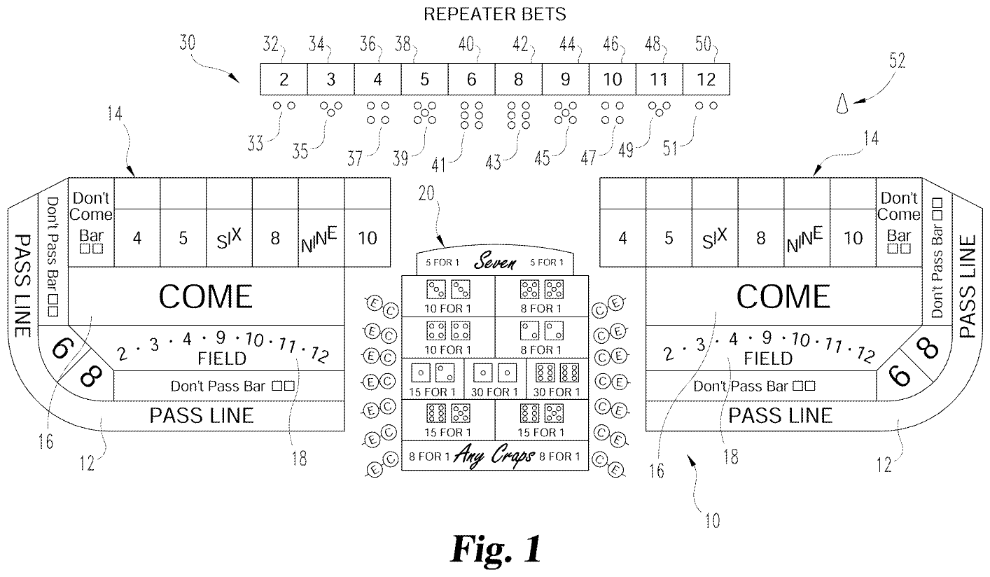

FIG. 1 shows one embodiment of a craps game according to one form of the present invention. The craps game may be played on a craps table similar to the traditional style, size and shape. The craps table has a horizontal playing surface upon which craps game layout 10 provided. The playing surface is typically made of felt, and is bound by a wall which supports a rail where players stand and may keep their chips. Alternatively, in another form, the craps game of the present invention may be played on a video screen using a layout comparable to that of craps game layout 10, such as by using a video craps machine as is known in the art in both console form and software form, such as for use by online casino operators.

The layout 10 includes several of the traditional craps wagering areas, including the pass line 12, place numbers 14, the come line 16, the field 18, and the proposition bets area 20. However, the craps game layout 10 also includes a repeater wagering area 30. In the repeater wagering area 30, players may place a bet that a selected predetermined number or group of numbers will be rolled a specified number of times, without a requirement that each number within the group be rolled, before a terminating event occurs. This type of bet will be referred to herein as a repeater bet. The repeater bet preferably has a relatively remote probability of occurrence when compared to the other more traditional wagers offered in a craps game, such as greater than 30 to 1. Therefore, a casino may offer relatively high odds on the various repeater bets offered by repeater wagering area 30. Accordingly, drawn by their desire to “win big,” new players will approach the craps table. Furthermore, because the craps game layout 10 retains the traditional craps wagering areas, the game retains all of the benefits of the traditional craps game.

The repeater wagering area 30 includes a bet area associated with at least one wager being conditioned upon the rolling of a number within a predefined non-empty set of numbers a specified number of times prior to the occurrence of a terminating event. In the simplest form, the defined set of numbers may be a single number, such as 2, 3, 4, 5, 6, 7, 8, 9, 10, 11, or 12. Alternatively, the defined set of numbers may include more than one number, such as the sets of 2 and 12, 3 and 11, 4 and 10, 5 and 9, and 6 and 8. Another suitable set may be all craps, including the numbers 2, 3, 11, and 12. As to the number of times a number must be rolled prior to the terminating even to win the bet, any number greater than one will suffice. However, given the quickly increasing odds, numbers between two and six are most preferred, while in an alternate preferred form number between seven and twelve may also be utilized to provide for even greater payouts. In one further form, a single number makes us the set of numbers and is also the specified number of times it is required to be rolled.

While various terminating events may be utilized with respect to repeater wagering area 30, the most common terminating event in the game of craps is the rolling of a seven (7) other than on the come out roll (hereinafter a “seven out”). Therefore the use of a “seven out” as a terminating event is preferred as it is already ingrained within the traditional game of craps, and is familiar to both existing players and casino staff. Accordingly, when the rolling of a seven is used as a terminating event, a seven cannot also be within a defined set of numbers to be repeated by any of the presented wagers.

According to the illustrated embodiment, representative repeater bets 32, 34, 36, 38, 40, 42, 44, 48, and 50 are provided for within repeater bet wagering area 30 of craps game layout 10. Tracking indicia 33, 35, 37, 39, 41, 43, 45, 47, 49, and 51 may also be provided on layout 10 to visually indicate the winning requirements of the bet and to also enable the casino staff to track the progress of the shooter toward the goal. In one form, the tracking indicia may include a number of marks to be covered up or progressed along by a marker in order to keep track of the number of the desired number(s) rolled so far since the last terminating event. Other forms of tracking indicia known to those of skill in the art, or as otherwise described herein, may be utilized.

A repeater bet is won when a player places a bet and the shooter rolls the predetermined number(s) the specified number of times, either sequentially or not, before the shooter “sevens out.” For example, in the case of repeater bet 32 which is shown illustratively in FIG. 1, it is won when the shooter rolls a two (2) twice, either sequentially or not, before the shooter “sevens out.” In the case of repeater bet 34, it is won when the shooter rolls a three (3) three times, either sequentially or not, before the shooter “sevens out.” Similarly, repeater bets 36, 38, 40, 42, 44, 46, 48, and 50 are won when the shooter rolls a four (4) four times, a five (5) five times, a six (6) six times, an eight (8) six times, a nine (9) five times, a ten (10) four times, an eleven (11) three times, or a twelve (12) twice, respectively, either sequentially or not, before the shooter “sevens out.”

In the illustrated form, the repeater bets within repeater wagering area 30 may only be placed when “coming out” so as to provide for ease of tracking the bets by the casino staff operating the game. Furthermore, in a further form, the limit for the repeater bets within repeater wagering area 30 may be defined, such as between $1 and $5, $1 and $10, or $1 and $20 to limit the casino's exposure to variance and to limit the potential for would be cheaters.

Furthermore, in the illustrated form, in the event the shooter establishes and makes a point during the duration of the repeater bet, the repeater bet is “off” for the come out roll. This is much like the option the player has to “work” their “hard ways” during a come out roll. However, in an alternate form, repeater bets within repeater wagering area 30 may collectively or individually “work” during the come out roll, but doing so on an individual basis may complicate the casino staff's bet tracking in much the same way that allowing the bets to be made other than on the come out roll would.

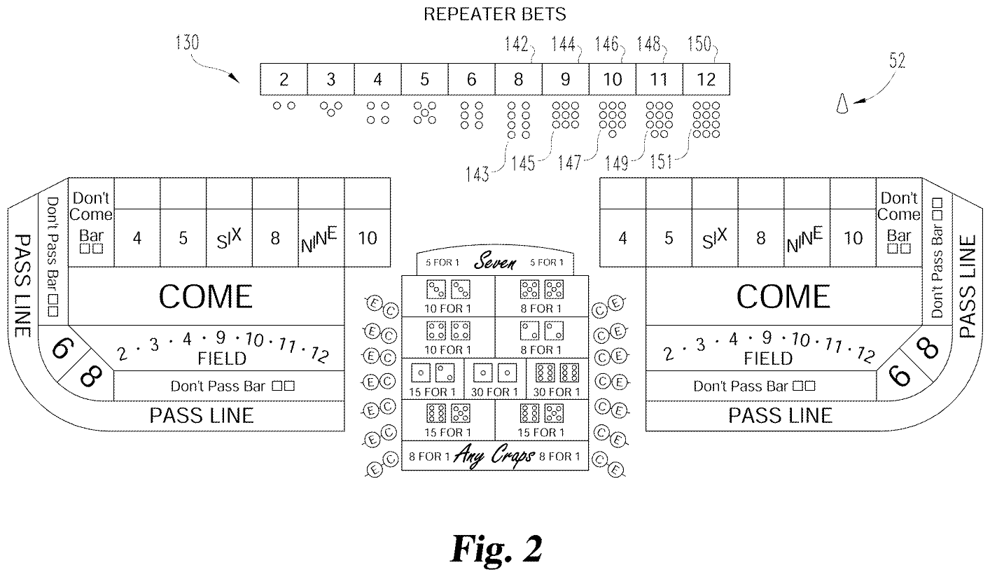

According to an alternate form, shown in FIG. 2, the specified number of rolls necessary to win repeater bets 42, 44, 46, 48, and 50 of FIG. 1 may continue upwards from the frequency of repeater bets 32, 34, 36, 38, and 40 to provide for even higher payouts within repeater wagering area 130. As illustrated, repeater bets 142, 144, 146, 148, and 150 are won when the shooter rolls an eight (8) eight times, a nine (9) nine times, a ten (10) ten times, an eleven (11) eleven times, or a twelve (12) twelve times, respectively, either sequentially or not, before the shooter “sevens out.” Accordingly, with these higher specified numbers, the tracking indicia 143, 145, 147, 149, and 151 may also provided for these higher levels of repeat to visually indicate the winning requirements of the bet and also enable the casino staff to track the progress of the shooter toward the goal.

Returning briefly to FIG. 1, the odds of the bets shown within repeater wagering area 30 along with exemplary payout odds and their respective house edge (or vigorish) are as follows:

| | | Odds | House |
|---|---|---|---|
| Bet | True Odds | Offered | Edge |
| Repeating “2” 2× (Bet 32) | 48:1 | 40 for 1 | 18.4% |
| Repeating “12” 2× (Bet 50) | | | |
| Repeating “3” 3× (Bet 34) | 63:1 | 50 for 1 | 21.9% |
| Repeating “11” 3× (Bet 48) | | | |
| Repeating “4” 4× (Bet 46) | 80:1 | 65 for 1 | 19.8% |
| Repeating “10” 4× (Bet 46) | | | |
| Repeating “5” 5× (Bet 38) | ~100:1 | 80 for 1 | ~20.8% |
| Repeating “9” 5× (Bet 44) | | | |
| Repeating “6” 6× (Bet 40) | ~112:1 | 90 for 1 | ~20.4% |
| Repeating “8” 6× (Bet 42) | | | |

The bets are combined in pairs within the same row where appropriate as bets having the same number of die combinations and required number of repeats to win share the same odds. Furthermore, it shall be appreciated that the actual payouts offered may be determined by the offering casino in order to achieve the desired house edge while still attracting players.

Returning briefly to FIG. 2, the odds of the increased bets shown within repeater wagering area 130, along with exemplary payout odds and their respective house edge (or vigorish) are as follows:

| | | Odds | |
|---|---|---|---|
| Bet | True Odds | Offered | House Edge |
| Repeating “8” 8× (Bet 142) | ~546:1 | 400 for 1 | ~26.9% |
| Repeating “9” 9× (Bet 144) | ~3800:1 | 2500 for 1 | ~34.2% |
| Repeating “10” 10× (Bet 146) | ~59,000:1 | 25,000 for 1 | ~40.7% |
| Repeating “11” 11× (Bet 148) | 4 Million:1 | 1M for 1 | ~75% |
| Repeating “12” 12× (Bet 150) | ~13 | 50M for 1 | ~99.6% |
| | Billion:1 | | |

Furthermore, it shall be appreciated that the actual payouts offered may be determined by the offering casino in order to achieve the desired house edge while still attracting players.

Given the extremely remote possibility of some of these winning occurrences, a casino operator may chose to employ only a selected number of these wagers. For example, with respect to FIG. 2, a casino may choose to provide only up to wager 144 or 146. This may be the case as payouts in excess of $25,000 or $1,000,000 not only expose the casinos to rather large potential for variance, but also provide far too significant of a risk for cheating. Accordingly, repeater wagering area 30 or 130 may include more or less than the wagers illustrated, along with any other wager type, having specified payout odds.

Alternatively, in a further form, escalating payouts may be provided when a shooter rolls only a portion of the selected number of the number(s), so long as more than a single roll is required. For example, with respect to repeater bet 150, a player may be paid a significantly lesser payout when six twelves (12) are rolled prior to the occurrence of a terminating event, and subsequently be paid more upon the occurrence of one or more future rolls of twelve (12) which are also prior to the occurrence of a terminating event. In this form, the extremely large jackpots can be provided for, but the player is also paid out for progress toward the jackpot to encourage them to keep playing.

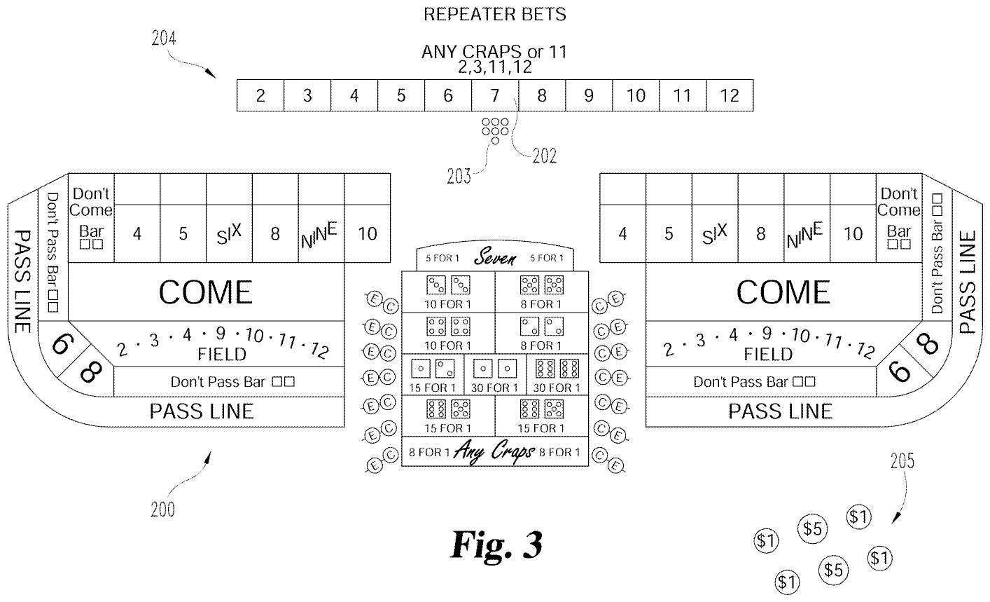

According to another alternate form, shown in FIG. 3, an additional repeater bet 202 may be added to repeater wagering area 204 of craps game layout 200 which is won when the shooter rolls any number within a non-empty set of numbers a specified number of times, either sequentially or not, before the shooter “sevens out.” This bet does not require that the same number be rolled the specified number of times, but only that any of the numbers within the set collectively be rolled the specified number of times. As illustrated, repeater bet 200, which in this form is based upon the set of numbers 2, 3, 11, and 12 is won when the shooter rolls seven of those numbers, either sequentially or not, before the shooter “sevens out.” Accordingly, tracking indicia 203 may also provided for these higher levels of repeat to visually indicate the winning requirements of the bet and also enable the casino staff to track the progress of the shooter toward the goal. In this example, the rolling of seven “craps” (how the numbers 2, 3, 11, and 12 are collectively know), such as a roll of 2, x, 11, x, 11, 2, x, 2, 3, 3 would win, so long as the “x”s are any number other than craps or a 7. For clarity, a shooter need not roll seven twos to win, but that would also win. Furthermore, the player can win without rolling each number at least once prior to the terminating event, as shown in the above example where a 12 was not rolled.

With respect to the repeater bet 200 of FIG. 3, its odds, along with exemplary payout odds and its respective house edge (or vigorish) are as follows:

| | | Odds | |
|---|---|---|---|
| Bet | True Odds | Offered | House Edge |
| Repeating “ANY CRAPS and 11” | 127:1 | 100 for 1 | ~21.9% |
| 7× (Bet 200) | | | |

With respect to FIGS. 1-3, the boxes within repeater wagering area 30 are illustrated as being sufficient in size to provide for the traditional placement of wagers according to the player's position around the table. In this form, one or more marking devices 52, such as a peg, chip, or the like are provided for use with tracking indicia 33, among others, to enable the casino staff to track the number of times a number has been rolled since the last “seven out” when necessary. This way, when the device 52 reaches the second to last of the tracking indicia, or all but the last tracking indicia is covered up by a device 52, the casino staff knows to pay the corresponding bet upon the rolling of the number again. Furthermore, when a “seven out” occurs, the casino staff removes all of the devices 52 and effectively reset these type bets within repeater wagering area 30.

Alternatively, in the event that repeater wagering area needs to be smaller, such as to accommodate existing craps game layouts, the boxes within repeater wagering area 30 may be reduced in size and separate chips 205 of acceptable and suitable denominations (depending upon the limits for repeater wagering area 30), capable of uniquely identifying players (such as by station or color), may be used to indicate a bet and/or track the progress the bet using tracking indicia 33, among others. In this form, the chips may be utilized in a manner similar to that of roulette, wherein each player has a separate color of chip which marks their bets. Of course, alternate methods of indicating the player associated with a particular bet known to those of skill in the art me be utilized.

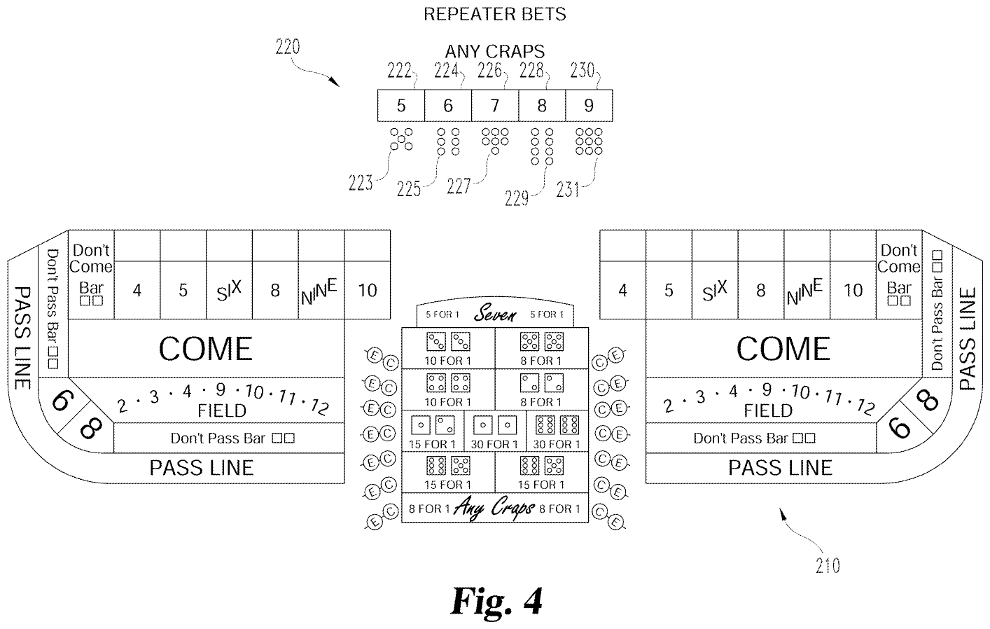

According to yet another alternate form, shown in FIG. 4, only a selected subset of the repeater bets shown in FIG. 1, along with the repeater bet 200 shown in FIG. 3 may be combined to form craps game layout 210. It shall be appreciated that any combination of the bets described herein may be combined in any fashion to provide for a suitable layout. The repeater bets contained within repeater wagering area 220 include repeater bets 222, 224, 226, 228, and 230. Also included are tracking indicia 223, 225, 227, 229, and 231. As described above with respect to repeater bets 38, 40, 42, and 44 of FIG. 1, repeater bets 222, 224, 228, and 230 are won when the shooter rolls the predetermined number indicated on the layout the specified number of times, either sequentially or not, before the shooter “sevens out.” As described above with respect to repeater bet 200, repeater bet 226, which in this form is based upon the smaller set of numbers 2, 3, and 12 (or ANY CRAPS) is won when the shooter rolls seven of those numbers, either sequentially or not, before the shooter “sevens out.” This variant of repeater bet 200 excludes the natural 11.

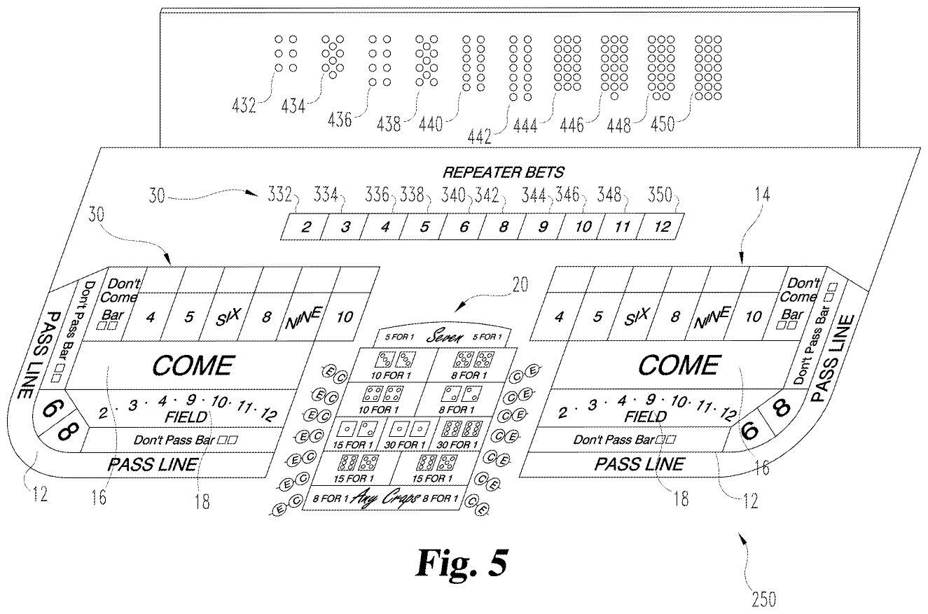

According to a further form, shown in FIG. 5, the tracking indicia described above are provided for in an electronic fashion. The craps game layout 250 shown in FIG. 5 is generally the same as that shown in FIG. 1, having the same repeater wagering area 30 and the same repeater bets 32, 34, 36, 38, 40, 42, 44, 46, 48 and 50. It shall be appreciated that the modifications made to the craps game layout 10 of FIG. 1 may be made to any of the layouts described or suggested herein to arrive at a comparable layout.

According to this form, each repeater bet 32, 34, 36, 38, 40, 42, 44, 46, 48 and 50 is associated with electronic tracking indicia 332, 334, 336, 338, 340, 342, 344, 346, 348 and 350. As illustrated, the electronic tracking indicia comprise one or more light emitting diodes (LEDs), which are preferably mounted to the craps game layout 250 near their respective repeater bet. For example, the tracking indicia 336 for repeater bet 36 may include three or four LEDs for tracking the number of fours rolled since the come out roll, or since the last “seven out.” The fourth LED may not be needed as upon the rolling of the fourth four the bet is to be paid and thus terminates. It shall be appreciated that the tracking indicia may take many other forms known to one of skill in the art including a digital display, tradition lamp, or the like. The various tracking indicia may be included within craps game layout 250, such as near or within the associated repeater bet box or may be otherwise mounted to the craps table, such as on the wall bounding the playing surface, in front of either the dealer or stick man boxes, so as to avoid interfering with the rolling of the dice.

Also provided in conjunction with each of electronic tracking indicia 332, 334, 336, 338, 340, 342, 344, 346, 348 and 350 is an electronic switch 432, 434, 436, 438, 440, 442, 444, 446, 448 and 450 or input which provides for control of the tracking indicia. It shall be appreciated that the electronic switch may take many forms known to one of skill in the art including a button, switch, knob, touch-screen, or the like. The various electronic switches may be included within craps game layout 250, such as near or within the associated repeater bet box or may be otherwise mounted to the craps table, such as behind the dealer or stick man boxes. As will be appreciated by one of skill in the art, in the illustrated embodiment, electronic tracking indicia 332, 334, 336, 338, 340, 342, 344, 346, 348 and 350 are controlled by an electronic controller, such as a electrical logic circuit implementing a finite state machine, computer or the like (not shown) which receives inputs from electronic switches 432, 434, 436, 438, 440, 442, 444, 446, 448 and 450.

As shall be appreciated from the foregoing, the wagers disclosed herein make the traditional craps game much more attractive to new players while maintaining the traditional wagers which made the game so popular. Many players refuse to play certain traditional craps wagers, such as many proposition bets, because the odds greatly favor the host. However, many players are willing to bet the odd smaller denomination chip on these proposition bets in order to put them in play rather than ultimately cash them in. Accordingly, the player is not concerned so much with the house edge as the potential for a large quick score. Thus, the concurrent wagers will not only increase the entertainment value and increase the play of a traditional craps game, but will also increase the game's notoriously low house advantage.

The wagering odds and suggested payouts in this specification are presented for illustrative purposes only. Actual wagering odds and payouts for particular wagers may be calculated at the operator's discretion, keeping in mind the limits of applicable federal, state, and local laws. Furthermore, it shall be appreciated that the actual payout odds would likely be displayed on the various layouts shown in the accompanying drawings, as is common in traditional craps games, to place the player on notice of the odds for each repeater bet.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected. Hence, the proper scope of the present invention should be determined only by the broadest interpretation of the appended claims so as to encompass all such modifications as well as all relationships equivalent to those illustrated in the drawings and described in the specification.

What is claimed is:

1. A craps game, comprising:
a craps game layout;
a pair of dice each having six faces bearing a visual representation of the numbers one through six, the dice being used to randomly generate a plurality of single roll dice outcomes calculated by adding a number from each die, the single roll dice outcomes including a plurality of point numbers and the number 7;
a pass line wagering area on the craps game layout for receiving a bet on a pass line wager, the pass line wager being won when one or more rolls of the dice yield an established point number prior to rolling the number 7;
a repeater wagering area for receiving a bet on a repeater wager, the repeater wager being won when a plurality of rolls of the dice match a predefined set of one or more numbers a specified number of times, either sequentially or not, without a requirement that more than one number within the set be rolled, prior to a roll yielding a defined terminating event; wherein said predefined set of numbers is associated with said repeater wager and said specified number of times is two or more.

2. The craps game of claim 1, wherein the predefined set of one or more numbers is a single number between 2 and 12.

3. The craps game of claim 2, wherein the predefined set of one or more numbers is a single number between 2 and 12, exclusive of 7.

4. The craps game of claim 3, wherein the terminating event is a seven out.

5. The craps game of claim 1, wherein the terminating event is a seven out.

6. The craps game of claim 4, wherein said singe number and said specified number of times are the same.

7. The craps game of claim 1, wherein the repeater wager of said repeater wagering area does not provide for an intermediate payout.

8. The craps game of claim 1, further comprising tracking indicia located adjacent to said repeater wagering area for tracking the progress toward matching the predefined set of one or more numbers the specified number of times.

9. The craps game of claim 8, wherein said tracking indicia located adjacent to said repeater wagering area for tracking the progress toward matching the predefined set of one or more numbers the specified number of times.

10. The craps game of claim 1, further comprising one or more unique sets of casino chips or markers, wherein each is labeled with a monetary amount for use in placing a bet on said repeater wager.

11. The craps game of claim 11, further comprising a plurality of repeater wagering areas for receiving a bet on one of a plurality of additional unique repeater wagers, wherein said repeater wager is distinct from each of said plurality of additional unique repeater wagers.

12. A craps game, comprising:
a craps game layout;
a pair of dice each having six faces bearing a visual representation of the numbers one through six, the dice being used to randomly generate a plurality of single roll dice outcomes calculated by adding a number from each die, the single roll dice outcomes including a plurality of point numbers and the number 7;
a pass line wagering area on the craps game layout for receiving a bet on a pass line wager, the pass line wager being won when one or more rolls of the dice yield an established point number prior to rolling the number 7;
a repeater wagering area for receiving a bet on a repeater wager, the repeater wager being won when a plurality of rolls of the dice match a single predefined number a specified number of times, either sequentially or not, prior to a roll yielding a defined terminating event; wherein said predefined set of numbers is associated with said repeater wager and said specified number of times is two or more.

13. The craps game of claim 12, wherein the single predefined number is between 2 and 12, exclusive of 7.

14. The craps game of claim 13, wherein the terminating event is a seven out.

15. The craps game of claim 14, wherein said singe predetermined number and said specified number of times are the same.

16. The craps game of claim 15, further comprising tracking indicia located adjacent to said repeater wagering area for tracking the progress toward matching the predefined number the specified number of times.

17. The craps game of claim 16, wherein said tracking indicia are electronic.

18. The craps game of claim 17, wherein said tracking indicia comprise at least one light emitting diode.

19. The craps game of claim 12, further comprising a set of unique casino chips or markers labeled with a monetary amount for use in placing a bet on said repeater wager.

20. The craps game of claim 12, further comprising a plurality of repeater wagering areas for receiving a bet on one of a plurality of additional unique repeater wagers, wherein said repeater wager is distinct from each of said plurality of additional unique repeater wagers.
